(19) United States
(12) Patent Application Publication
(10) Pub. No.: US 2008/0228326 A1
(43) Pub. Date: Sep. 18, 2008

(54) PARALLEL CONNECTION DEVICE AND POWER SUPPLY DEVICE USING THE SAME

(75) Inventors: Chang-Hsing Chen, Taipei (TW); Sheng-Wei Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SOLYTECH ENTERPRISE CORPORATION, Taipei (TW)

(21) Appl. No.: 11/685,783

(22) Filed: Mar. 14, 2007

(51) Int. Cl. G05D 3/12

(52) U.S. Cl. 700/295

(57) ABSTRACT

A parallel connection device for a personal computer is provided. The personal computer includes a motherboard, a first power supplier, and a second power supplier. The parallel connection device includes a first power plug, a second power socket, and a third power socket. The first power plug is connected to a first power socket of the motherboard. Through a second power plug, the first power supplier is connected to the second power socket. Through a third power plug, the second power supplier is connected to the third power socket. Therefore, the load of the first and the second power suppliers can be reduced.

### BACKGROUND OF THE INVENTION

1. Field of the Invention

The present invention relates to a power supply device of a personal computer. More particularly, the present invention relates to a parallel connection device for connecting a plurality of power supply devices of the personal computer in parallel.

2. Description of Related Art

With the advance of computer industry, power supplier has become one of indispensable products. Moreover, with the development of high-level products, more power is consumed by the personal computer (PC), and the load of the power supplier increasingly becomes high. If the power supplier provides an unstable power or a power with deficient wattages, a computer is easily down, and the data in the computer is lost, or even worse the high-level products in the computer are damaged, thus causing inconveniences to consumers, and wasting a lot of money for purchasing a new hardware.

Therefore, each manufacturer devotes lots of people and money in the research and development of the power supplier with high power. However, as it is difficult to develop the power supplier with high power and the material is expensive, the price of the power supplier with high power in the market is always high at present. For example, if the power of the power supplier is doubled, usually the price of the power supplier is increased by several folds or several ten folds.

According, the relevant manufacturers of the power supplier are in an urgent need for a suitable solution to reduce the cost.

### SUMMARY OF THE INVENTION

Accordingly, the present invention is directed to a power supply device, thereby reducing cost.

The present invention provides a parallel connection device, for connecting a plurality of power suppliers in parallel, so as to reduce the load of each power supplier.

The present invention provides a power supply device for the personal computer. The personal computer includes a motherboard having a first power socket. The power supply device includes a parallel connection device, a first power supplier, and a second power supplier. The parallel connection device includes a first power plug, a second power socket, a first power line unit, a third power socket, and a second power line unit. The first power plug is used to connect to the first power socket. The first power line unit is electrically connected between the first power plug and the second power socket. The second power line unit is electrically connected between the first power plug and the third power socket. In addition, the first power supplier has a second power plug for connecting to the second power socket to provide power to the motherboard. The second power supplier has a third power plug for connecting to the third power socket to provide power to the motherboard.

In an embodiment of the present invention, the second power line unit includes a delay device for delaying the control signal of the motherboard. The delay device, for example, includes a transistor, a resistor, and a capacitor. The transistor has a gate end coupled to the first power plug, a collector coupled to the first voltage, and an emitter coupled to the third power socket. A first end of the resistor is coupled to the emitter of the transistor. A first end of the capacitor is coupled to the second end of the resistor, and a second end of the capacitor is coupled to the second voltage.

In an embodiment of the present invention, the first and the second power line units include a diode unit for preventing counter current. In another embodiment, the first and the second power line units further include a feedback switching switch coupled between the diode unit and the first power plug, for compensating the voltage drop caused by the diode unit. In still another embodiment, the first and the second power suppliers include a feedback switching switch, for compensating the voltage drop caused by the diode unit.

In an embodiment of the present invention, the power supply device further includes a first warning circuit and a second warning circuit. The first and the second warning circuits are respectively used to monitor whether the first and the second power suppliers operate normally or not. In another embodiment, the first and the second power suppliers are ATX, SFX, LFX, or TFX specification. In still another embodiment, the parallel connection device includes an analog OR gate circuit or an analog AND gate circuit, and has a first input end receiving a first power good (PG) signal of the first power supplier, a second input end receiving a second PG signal of the second power supplier, and an output end providing a third PG signal to the motherboard.

The present invention provides a parallel connection device for the personal computer. The personal computer includes a motherboard, a first power supplier, and a second power supplier. The parallel connection device includes a first power plug, a second power socket, a first power line unit, a third power socket, and a second power line unit. The first power plug is used to connect to the first power socket of the motherboard. The first power line unit is electrically connected between the first power plug and the second power socket. The second power line unit is electrically connected between the first power plug and the third power socket. The first power supplier has a second power plug, for connecting to the second power socket to provide power to the motherboard. The second power supplier has a third power plug, for connecting to the third power socket to provide power to the motherboard.

In the present invention, the parallel connection device is adopted to connect a plurality of power suppliers in parallel to provide power to a same motherboard, such that the load of each power supplier can be reduced.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a power supply device using a parallel connection device according to a first embodiment of the present invention.

FIG. 2 is a schematic view of pins of a power plug and a socket according to a first embodiment of the present invention.

FIG. 3 is a schematic view of a power supply device using a parallel connection device according to a second embodiment of the present invention.

FIG. 4 is a schematic view of a delay device according to a second embodiment of the present invention.

FIG. 5 is a schematic view of a parallel connection device using a diode unit according to a second embodiment of the present invention.

FIG. 6 is a schematic view of a parallel connection device using a feedback switching switch according to a third embodiment of the present invention.

FIG. 7 is a schematic view of a power supplier using a feedback switching switch according to a fourth embodiment of the present invention.

FIG. 8 is a schematic view of a power supplier using a feedback circuit according to a fifth embodiment of the present invention.

FIG. 9 is a schematic view of a feedback circuit of the power supplier capable of regulating the output voltage according to a fifth embodiment of the present invention.

FIG. 10 is a schematic view of a warning circuit according to a sixth embodiment of the present invention.

FIG. 11 is a schematic view of an analog OR gate circuit according to a seventh embodiment of the present invention.

FIG. 12 is a schematic view of an analog OR gate circuit according to an eighth embodiment of the present invention.

FIG. 13 is a schematic view of a power supply device using a parallel connection device according to a ninth embodiment of the present invention.

FIG. 14 is a schematic view of a power supply device using a parallel connection device according to a tenth embodiment of the present invention.

### DESCRIPTION OF EMBODIMENTS

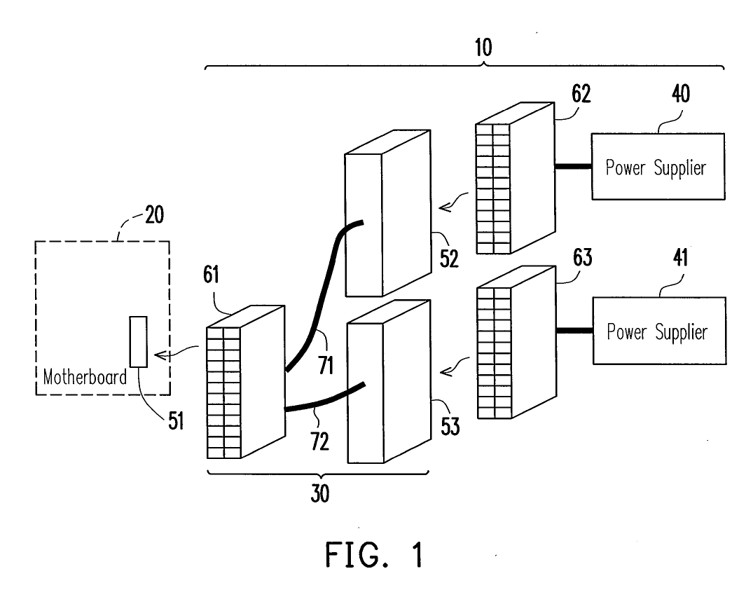

FIG. 1 is a schematic view of a power supply device using a parallel connection device according to a first embodiment of the present invention. Referring to FIG. 1, a power supply device 10 is suitable for a personal computer. The personal computer includes a motherboard 20, and the motherboard 20 has a power socket 51. The power supply device 10 includes a parallel connection device 30, a power supplier 40, and a power supplier 41. The power suppliers 40, 41 are, for example, ATX, SFX, LFX, or TFX specification. The parallel connection device 30 includes a power plug 61, a power socket 52, a power line unit 71, a power socket 53, and a power line unit 72. The power plug 61 is used to connect to the power socket 51. The power line unit 71 is electrically connected between the power plug 61 and the power socket 52. The power line unit 72 is electrically connected between the power plug 61 and the power socket 53.

Accordingly, the power suppliers 40, 41 are respectively connected to the power sockets 52 and 53 through the power plugs 62 and 63 for providing power to the motherboard. In another words, the power suppliers 40, 41 can simultaneously provide the power to the motherboard. In this manner, not only the load of the power suppliers 40, 41 is reduced, but also the stability of the power is increased. In addition, it should be mentioned that the power suppliers 40, 41 receive the control signal (e.g. PS_ON signal) of the motherboard 20 through the parallel connection device 30. That is, the motherboard 20 can control whether the power suppliers 40, 41 are turned on or off. Therefore, the trouble of manually turning on or off the power suppliers 40, 41 can be omitted. In addition, in the above embodiment, from another point of view, the personal computer can also be considered to include the motherboard 20 and the power suppliers 40, 41. Next, each pin of the power plugs 61-63 and power sockets 51-53 will be described in detail for the illustration of each embodiment as follows.

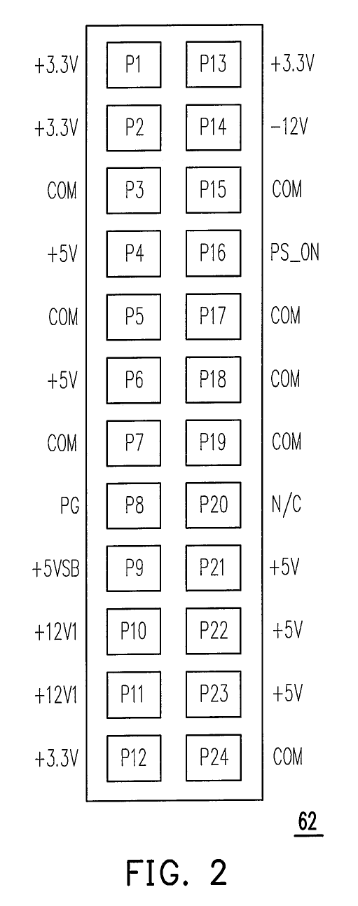

FIG. 2 is a schematic view of pins of a power plug and a socket according to a first embodiment of the present invention. Referring to FIGS. 1 and 2 together, the power plug 62 is set as an example for illustration, and the power plugs 61, 63 and the power sockets 51-53 will not be described. In this embodiment, the number of pins of the power plug 61 is, for example, 24 (P1-P24) for illustration. In other embodiments, the definition and number of pins of the power plug 61 can also be changed as required. Similarly, in this embodiment, the power line units 71, 72 respectively have 24 wires. The voltage and the color of wire of each pin are listed in Table 1 as follows.

TABLE 1
Signal and Color of Each Pin

| Pin | Signal (voltage) | Color |
|---|---|---|
| P1 | DC +3.3 V | orange |
| P2 | DC +3.3 V | orange |
| P3 | COM | black |
| P4 | DC +5 V | red |
| P5 | COM | black |
| P6 | DC +5 V | red |
| P7 | COM | black |
| P8 | PG | gray |
| P9 | stand-by +5 V | purple |
| P10 | DC +12 V1 | yellow |
| P11 | DC +12 V1 | yellow |
| P12 | DC +3.3 V | orange |
| P13 | DC +3.3 V | orange |
| P14 | DC −12 V | blue |
| P15 | COM | black |
| P16 | PS_ON | green |
| P17 | COM | black |
| P18 | COM | black |
| P19 | COM | black |
| P20 | reserved | N/C |
| P21 | DC +5 V | red |
| P22 | DC +5 V | red |
| P23 | DC +5 V | red |
| P24 | COM | black |

In Table 1, DC+3.3V, +5V, −12V, and +12V stand for DC+3.3V, +5V, −12V, and +12V supplied by the power supplier 40 in a starting state, but the power supplier 40 does not supply voltage in a standby state. COM is the grounding (voltage=0 V). The PG signal is the signal returned to the motherboard 20 when the power supplier 40 finishes preparation. When the PG is at a logic high level, it indicates that the operation of the power supplier 40 is good. On the contrary, when the PG is at a logic low level, it indicates that the operation of the power supplier 40 is poor. Standby +5 V indicates that the power supplier 40 provides a voltage of DC 5 V in the starting state or the standby state. PS_ON is the control signal of the motherboard 20 controlling whether the power supplier 40 is turned on or off (entering the starting state or the standby state). The pin P20 is a reserved pin, and is not used temporarily.

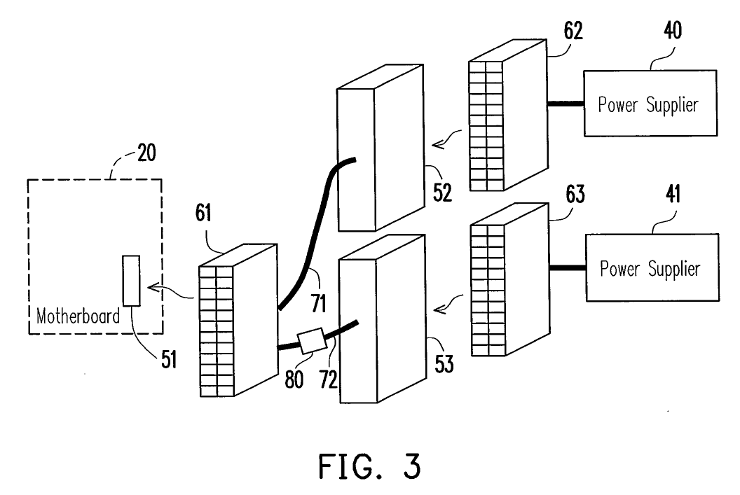

Those of ordinary skill in the art can change the implementation according to the spirit of the present invention and the teaching of the above embodiment based on the requirement. For example, FIG. 3 is a schematic view of the power supply device using a parallel connection device according to a second embodiment of the present invention. Referring to FIG. 3, elements in this embodiment with reference to the device of the above embodiment can be indicated by the same reference numerals. It should be noted that in consideration of a control requirement to prevent signals interfering each other, the power line unit 70 can be disposed in the delay device 80. The delay device 80 is used to delay the control signal (PS_ON signal) of the motherboard 20, for example, 20 ms. In this manner, the power supplier 40 is turned on earlier than the power supplier 41, thereby avoiding the unstable circumstance of the power system. People using the present invention may determine whether or not to use the delay device 80 as required. Then, the delay device 80 is further described as follows.

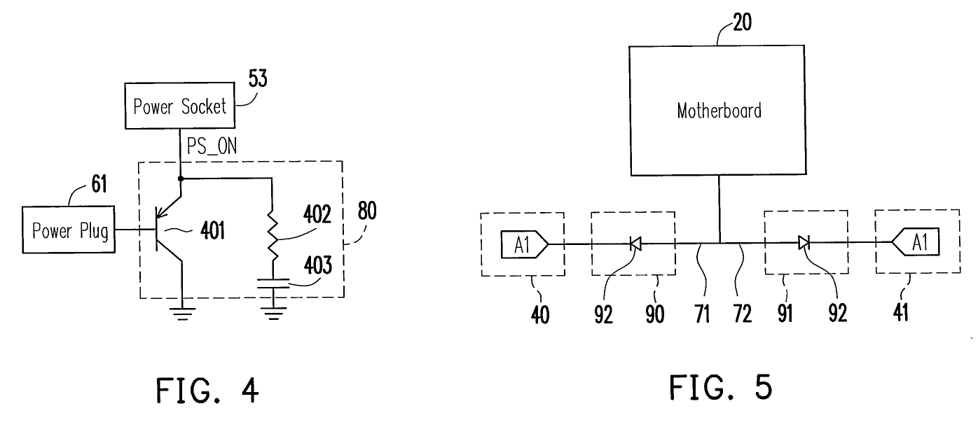

FIG. 4 is a schematic view of a delay device according to a second embodiment of the present invention. Referring to FIGS. 3 and 4 together, the delay device 80, for example, includes a transistor 401, a resistor 402, and a capacitor 403. A gate end of the transistor 401 is coupled to the power plug 61. A collector of the transistor 401 is coupled to the first voltage, for example the COM voltage of the power line unit 72. An emitter of the transistor 401 is coupled to the power socket 53. A first end of the resistor 402 is coupled to the emitter of the transistor 401. A first end of the capacitor 403 is coupled to the second end of the resistor 402, and the second end of the capacitor 403 is coupled to the second voltage, for example the COM voltage of the power line unit 72. Therefore, the resistor 402 and the capacitor 403 form a resistance capacitance (RC) circuit having a delay effect, thereby delaying the control signal (for example, PS_ON signal) of the motherboard 20.

Those of ordinary skill in the art can dispose a diode unit on the power line units 71, 72 as required, so as to prevent counter current. For example, FIG. 5 is a schematic view of a parallel connection device using a diode unit according to a second embodiment of the present invention. Referring to FIGS. 3 and 5, in this embodiment, the power line units 71, 72 respectively include diode units 90, 91, the diode units 90, 91 may has diodes 92 of different number (for example a plurality of diodes 92 connected in parallel) and in different direction according to different requirements.

For example, when A1 end of the power supplier 40 and A2 end of the power supplier 41 provide a negative voltage (e.g. −12V) to the motherboard 20. The diode unit 90 is coupled between the power supplier 40 and the motherboard 20. A cathode of the diode 92 is coupled to the power supplier 40, an anode of the diode 92 is coupled to the motherboard 20. The diode unit 91 can be deduced from the above description. In this manner, the counter current of the power suppliers 40, 41 is prevented. It should be noted that if the power provided by the power suppliers 40, 41 has a positive voltage, the coupling direction of the diode 92 is changed correspondingly, and the counter current can also be prevented.

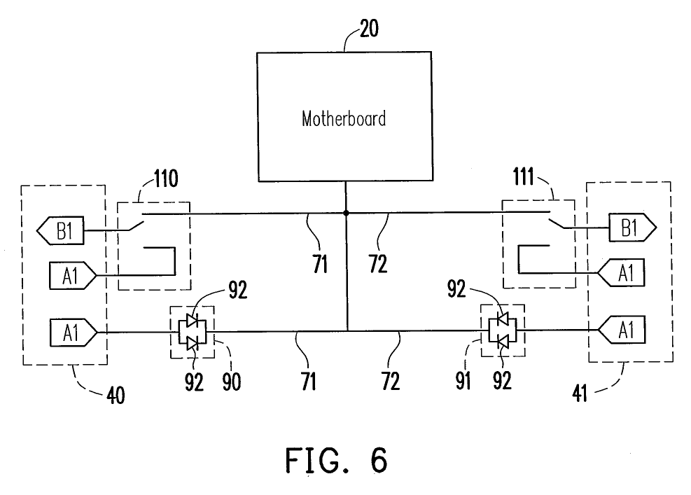

In view of the above embodiment, the diode units 90, 91 may somewhat cause the drop of voltage provided by the power suppliers 40, 41. Therefore, in order to prevent the voltage drop caused by the diode units 90, 91, those of ordinary skill in the art can dispose a feedback switching switch on the power line units 71, 72 respectively as required, thereby correcting the voltage bias. For example, FIG. 6 is a schematic view of a parallel connection device using a feedback switching switch according to a third embodiment of the present invention. Referring to FIGS. 3 and 6 together, in this embodiment, the power supplier 40 has end points A1 and B1. The power supplier 41 has end points A2 and B2. It is assumed that the end points A1 and A2 provide the voltage of 5 V to the motherboard 20. However, the voltage drop caused by the diode units 90, 91 may result in that the voltage received by the motherboard 20 is lower than 5 V, for example, is 4.7 V.

Accordingly, a feedback switching switch 110 is disposed between the diode unit 90 and the power supplier 40 (or the power plug 52), so as to compensate the voltage drop caused by the diode unit 90 by means of feedback. It should be noted that when the power suppliers 40, 41 are used in parallel, the feedback switching switch 110 is switched to make the end point B1 coupled to the motherboard 20, thereby feeding the biased voltage back to the power supplier 40. On the contrary, when the power suppliers 40, 41 are used separately, the feedback switching switch 110 can be switched to make the end point BI coupled to the end point Al, thereby performing feedback compensation by using the voltage in the power supplier 40. The feedback switching switch 111 can be deduced from the above description, and the details will not be described herein.

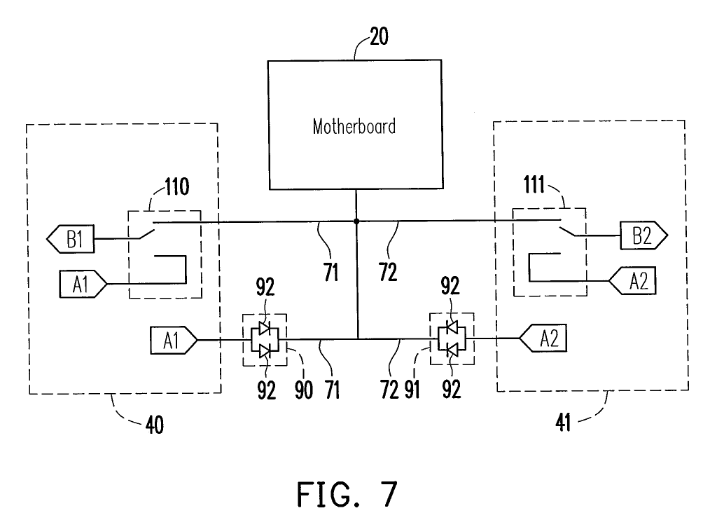

Those of ordinary skill in the art can change the disposed position of the feedback switching switch according to the spirit of the present invention and the teaching of the above embodiments as required. For example, FIG. 7 is a schematic view of a power supplier using a feedback switching switch according to a fourth embodiment of the present invention. Referring to FIGS. 3 and 7, the elements with the same numerals of the above embodiments can refer to the implementation of the above embodiments. It should be particularly noted that in this embodiment, the feedback switching switches 110, 111 are disposed in the power suppliers 40, 41, respectively.

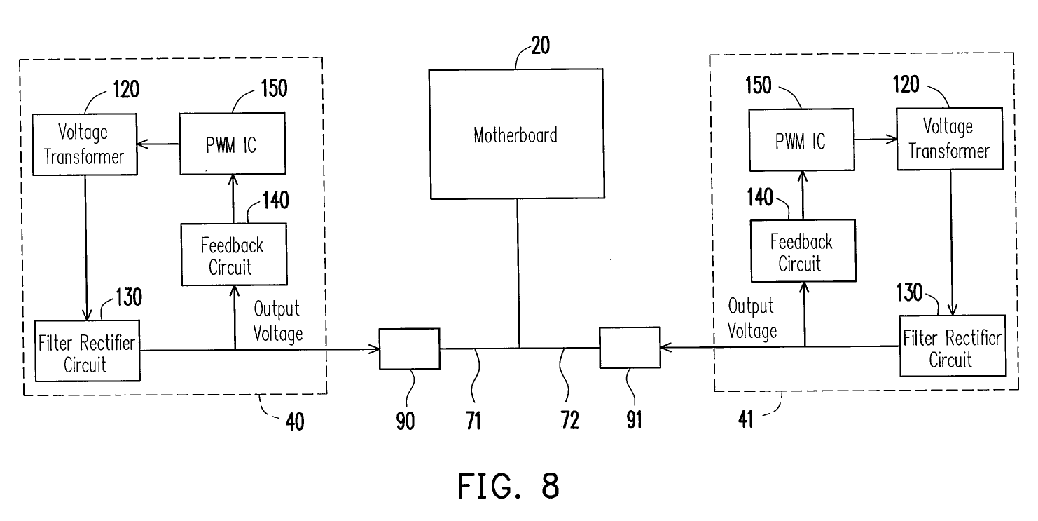

Those of ordinary skill in the art can prevent the voltage bias caused by the diode unit according to the spirit of the present invention and the teaching of the above embodiments as required. For example, FIG. 8 is a schematic view of a power supplier using a feedback circuit according to a fifth embodiment of the present invention. Referring to FIG. 8, the elements with the same numerals of the above embodiments can refer to the implementation of the above embodiments. In this embodiment, the power suppliers 40, 41 respectively include a voltage transformer 120, a filter rectifier circuit 130, a feedback circuit 140, and a pulse width modulation IC (PWM IC) 150.

Accordingly, the voltage transformer 120 is used to transform voltage, for example, from high to low or from low to high. The filter rectifier circuit 130 is used to stabilize, reform the voltage waveform, or transform AC to DC. The feedback circuit 140 is responsible for monitoring the bias of the output voltage, thereby performing voltage feedback compensation. The PWM IC 150 assists the voltage transformer 120 to perform voltage regulation according to a monitor signal of the feedback circuit 140. As the diode units 90, 91 may cause the voltage bias, the output voltage of the power suppliers 40, 41 can be directly regulated, thereby compensating the voltage bias caused by the diode units 90, 91. For example, the power supplier 40 should provide a voltage of 3.3 V to the motherboard 20, but the diode unit 90 cause the voltage drop of 0.3 V, so the motherboard 20 only receives a voltage of 3 V. Therefore, in this embodiment, the output voltage of the power supplier 40 is regulated, such that a voltage of 3.6 V is output. In this manner, the motherboard 20 can receives a voltage of 3.3 V.

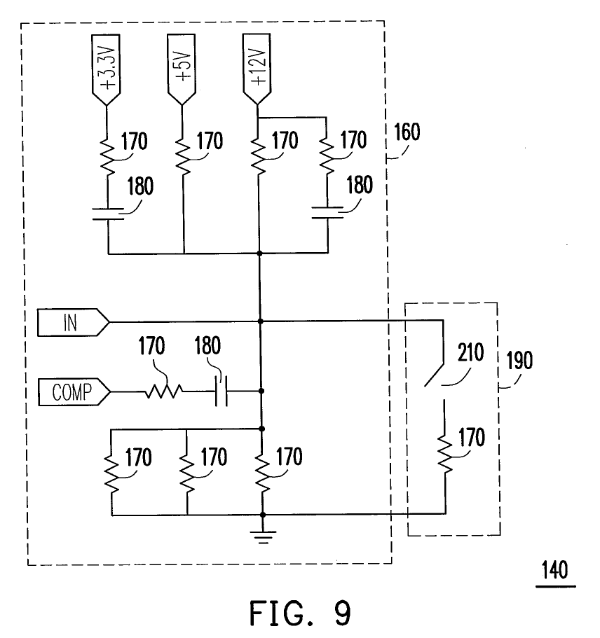

According to the above embodiment, those of ordinary skill in the art can dispose the feedback switching switch in the power suppliers 40, 41 to help to regulate the output voltage of the power suppliers 40, 41 as required. FIG. 9 is a schematic view of a feedback circuit of a power supplier capable of regulating the output voltage according to a fifth embodiment of the present invention. Referring to FIGS. 8 and 9 together, the feedback circuit 140 includes a rising circuit 160 and a switching switch unit 190. The rising circuit 160 includes a plurality of resistors 170 and capacitors 160, which is a conventional art and will not be described herein.

It should be noted that the switching switch unit 190 includes a feedback switching switch 210 and a resistor 170. The switching switch unit 190 can change the circuit resistance ratio of the upper and lower circuits of the rising circuit 160, thereby changing the monitor signal output by the feedback circuit 140 to the PWM IC 150, and further changing the output voltage of the power suppliers 40, 41, so as to avoid the voltage bias caused by the diode units 90, 91.

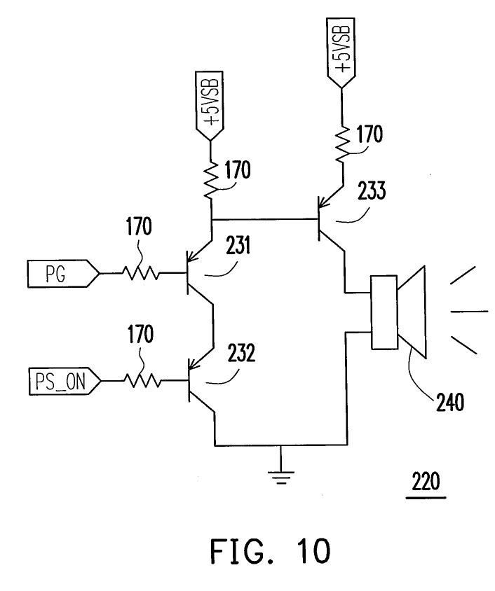

Those of ordinary skill in the art can use the warning circuit according to the spirit of the present invention and the teaching of the above embodiments as required. For example, FIG. 10 is a schematic view of a warning circuit according to a sixth embodiment of the present invention. Referring to FIG. 10, in this embodiment, +5VSB, PG, and PS_ON are respectively the pins P9, P8, and P16 of the power supplier. The warning circuit 220 includes a plurality of resistors 170 and transistors 231-233. When the PG is at the logic low level (the power supplier generates errors), the transistor 231 is in the turn-on state. On the contrary, when the PG is at the logic high level (no error occurs to the power supplier), the transistor 231 is in the turn-off state. Therefore, when the user presses a power switch (not shown) of a computer host (not shown), the PS_ON outputs a signal of the logic low level to turn on the transistor 232. At this time, if the transistor 231 is also in the turn-on state, the transistor 233 is turned on, a buzzer 240 sounds to warn the user that the power supplier generates errors. In other embodiments, indicator lamps are used to replace the buzzer 240, and the details will not be described herein. In addition, it should be noted that a plurality of warning circuits 220 are respectively used to monitor the operation state of a plurality of power suppliers in real time. Those of ordinary skill in the art can dispose the warning circuit 220 in each power supplier or integrate it into the parallel connection device or the computer host as required.

Referring to FIG. 1 continuously, those of ordinary skill in the art can change the implementation of the parallel connection device 30 according to the spirit of the present invention and the teaching of the above embodiments of the present invention as required. For example, an analog OR gate circuit is added in the parallel connection device 30 to solve the problem that the motherboard 20 can only receives the pin P8 of the power supplier 40 or the power supplier 41. A first input end of the analog OR gate circuit receives the PG signal PG1 of the power supplier 40. A second input end of the analog OR gate circuit couples the PG signal PG2 of the power supplier 41. An output end of the analog OR gate circuit is coupled to the motherboard 20. In this manner, when the power supplier 40 or 41 can operate normally, the motherboard 20 may determine whether the power supply device 10 is ready. In other words, as long as one of the power suppliers 40, 41 can provide power to the motherboard 20, the motherboard 20 can be started successively. From another point of view, if one of the power suppliers 40, 41 fails, the motherboard 20 can still operate normally. Then, the implementation of the analog OR gate circuit is further described in details below.

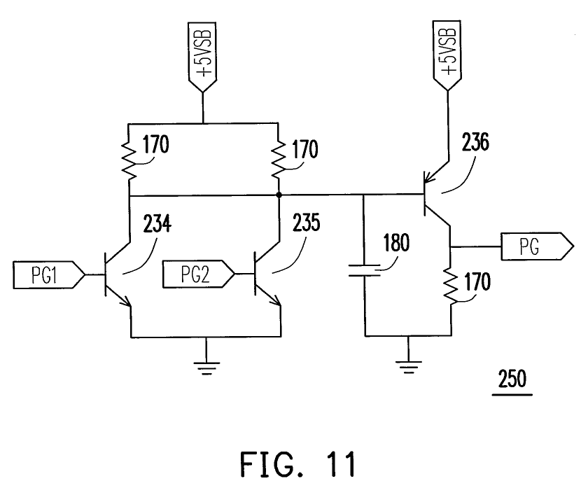

FIG. 11 is a schematic view of an analog OR gate circuit according to a seventh embodiment of the present invention. Referring to FIGS. 1 and 11, in this embodiment, the analog OR gate circuit 250 includes a plurality of resistors 170, a capacitor 180, and transistors 234-236. The analog OR gate circuit 250 has two input ends for receiving the PG signal PG1 of the power supplier 40 respectively, the PG signal PG2 of the power supplier 41, and outputs the output signal PG to the motherboard 20. In this embodiment, the transistors 234 and 235 are NMOS transistors, and the transistor 236 is a P MOS transistor. Those of ordinary skill in the art should know the operation principle of the analog OR gate circuit 250, so it will not be described herein, and the remaining part can refer to the true value table of Table 2. 1 stands for the logic high level, and 0 stands for the logic low level. In another words, only when the power suppliers 40, 41 fail simultaneously, the motherboard 20 generates errors. Therefore, when the wattages output by a single power supplier is sufficient to meet the operational requirement of the motherboard 20, the user can use only a single power supplier (40 or 41) to provide electric energy required by the motherboard 20. Definitely, the user can also use a plurality of power suppliers (e.g. power suppliers 40, 41) to simultaneously supply the electric energy required by the motherboard 20.

TABLE 2
True Value Table of Analog OR Gate Circuit 250
and Conduction State of Each Transistor

| | Transistor | | Transistor | Transistor | |
|---|---|---|---|---|---|
| PG1 | 234 | PG2 | 235 | 236 | PG |
| 0 | OFF | 0 | OFF | OFF | 0 |
| 0 | OFF | 1 | ON | ON | 1 |
| 1 | ON | 0 | OFF | ON | 1 |
| 1 | ON | 1 | ON | ON | 1 |

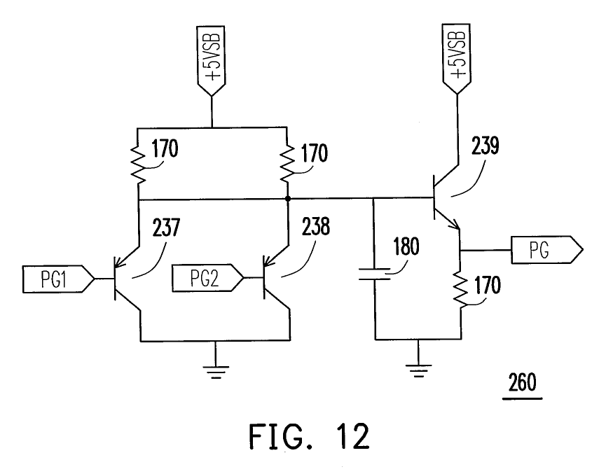

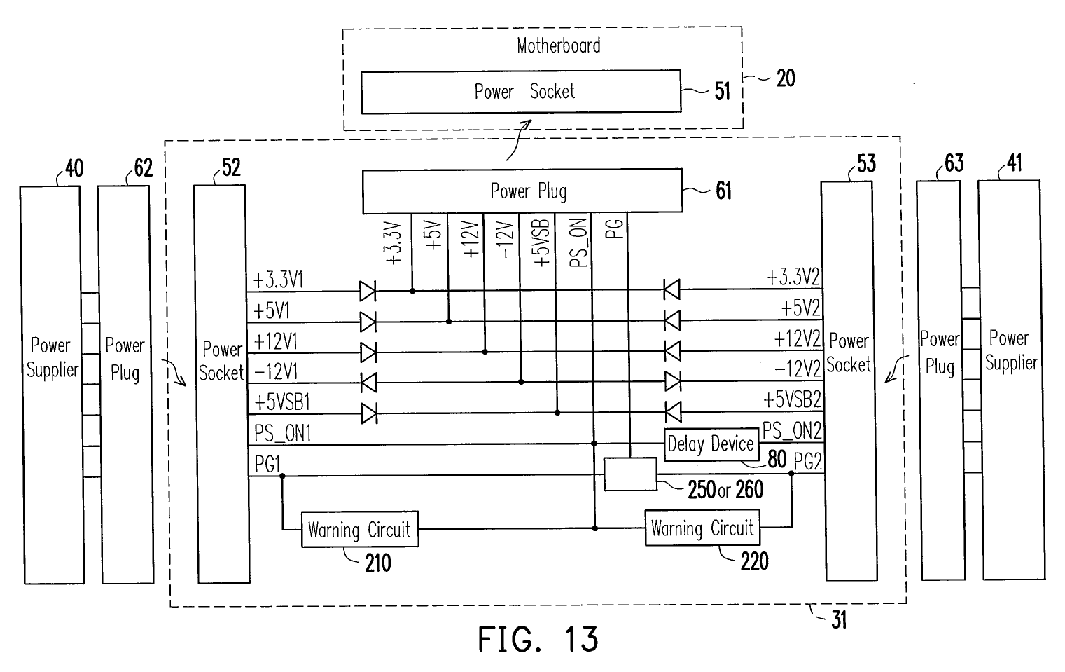

If the failure of one of the power suppliers 40, 41 affects the operation of the motherboard 20, those of ordinary skill in the art can change the analog OR gate circuit of the above embodiment to the analog AND gate circuit. For example, FIG. 12 is a schematic view of the analog OR gate circuit according to an eighth embodiment of the present invention. Referring to FIGS. 1 and 12 together, in this embodiment, the analog AND gate circuit 260 includes a plurality of resistors 170, a capacitor 180, and transistors 237-239. The analog AND gate circuit 260 has two input ends for receiving the PG signal PG1 of the power supplier 40, the PG signal PG2 of the power supplier 41 respectively, and outputs the output signal PG to the motherboard 20. In this embodiment, the transistors 237 and 238 are PMOS transistors, and the transistor 239 is an NMOS transistor. Those of ordinary skill in the art should know the operation principle of the analog OR gate circuit 260, so it will not be described herein, and the remaining part can refer to the true value table of Table 3.

In Table 3, 1 stands for the logic high level, and 0 stands for the logic low level. In other words, as long as one of the power suppliers 40, 41 fails, the motherboard 20 can acquire that one of the power suppliers 40, 41 fails. From another point of view, only when the power suppliers 40, 41 operate normally, the motherboard 20 can operate normally, which is advantageous in overcoming the problem of unstable power supply or the overload caused by only one of the power suppliers 40, 41 being used to provide power to the motherboard 20. In addition, it should be noted that those of ordinary skill in the art could use each analog logic circuit to determine the PG signal provided to the motherboard in different logic combinations.

TABLE THREE
True Value Table of Analog AND Gate Circuit 260 and
Conduction State of Each Transistor

| | Transistor | | Transistor | Transistor | |
|---|---|---|---|---|---|
| PG1 | 237 | PG2 | 238 | 239 | PG |
| 0 | ON | 0 | ON | OFF | 0 |
| 0 | ON | 1 | OFF | OFF | 0 |
| 1 | OFF | 0 | ON | OFF | 0 |
| 1 | OFF | 1 | OFF | ON | 1 |

Those of ordinary skill in the art can integrates the teaching of the above embodiments in one embodiment according to the spirit of the present invention. For example, FIG. 13 is a schematic view of a power supply device using a parallel connection device according to a ninth embodiment of the present invention. Referring to FIG. 13, the switching feedback switch and the feedback line are omitted in FIG. 13 for the purpose of simplification, but the part can be integrated in the parallel connection device 31 or the power suppliers 40, 41 with reference to the implementation of the above embodiments. People using the present invention can determine whether to omit the delay device 80 as required, so as to simultaneously start the power suppliers 40, 41. In addition, people using the present invention can selectively omit a part of the diodes (for example the diode coupled to +5VSB1 and +5VSB2) in FIG. 13.

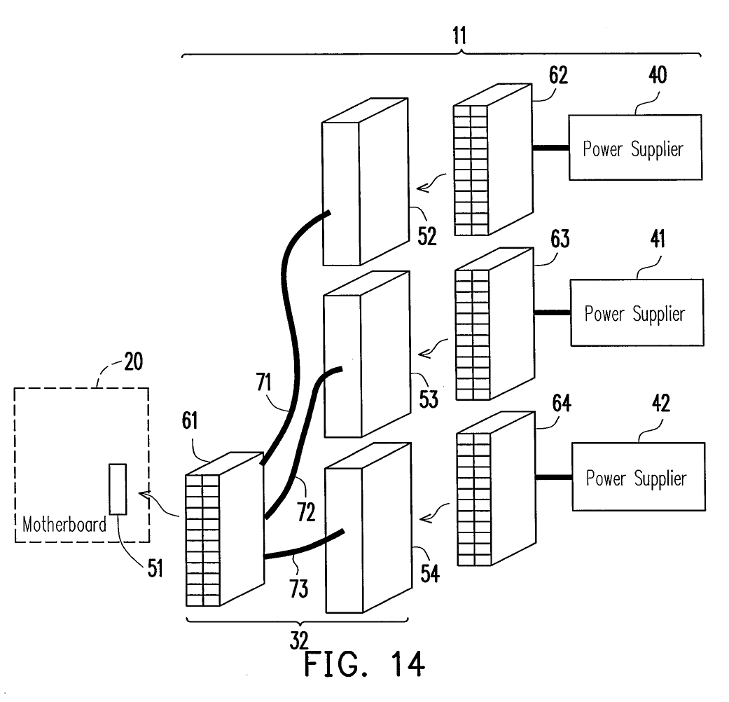

Those of ordinary skill in the art can change the number of the power suppliers and correspondingly change the number of the power sockets and the power line units of the parallel connection device as required. For example, FIG. 14 is a schematic view of a power supply device using a parallel connection device according to a tenth embodiment of the present invention. Referring to FIG. 14, in this embodiment, the power supply device 10 includes a parallel connection device 31, and power suppliers 40, 41 and 42. The parallel connection device 31 includes a power plug 61, power sockets 52, 53, and 54, and power line units 71, 72, and 73. The implementation of remaining parts can refer to the embodiment of FIG. 1, and will not be described herein. In this manner, the power suppliers 40, 41, and 42 can provide current to the motherboard 20 simultaneously by the use of the parallel connection device 32, which is advantageous in reducing the load of the power suppliers 40, 41, and 42, and improving the stability of power.

It should be noted that although in the above embodiments, the possible forms of the parallel connection device and the power supply device are described, those of ordinary skill in the art should know that each manufacturer has a different design of the parallel connection device and the power supply device. Therefore, the application of the present invention is not limited in the possible forms. In other words, as long as a plurality of power suppliers is connected in parallel by the parallel connection device to provide power to the motherboard, it conforms to the spirit of the present invention.

To sum up, the embodiments of the present invention at least have the following advantages.

1. A plurality of power suppliers is connected in parallel by the parallel connection device to provide power to the motherboard, thereby reducing the load of each power supplier and improving the stability of power.

2. The delay device is used to determine the sequence in which the motherboard starting the plurality of power suppliers, so as to prevent the conflict of the plurality of the power suppliers.

3. The diode unit is disposed on the parallel connection device to prevent the counter current, and the feedback switching switch is used together to prevent the diode unit causing the voltage bias of the output voltage of the power supplier.

4. The warning device is used to monitor whether each power supplier operates normally in real time, so as to prevent the errors of other devices as the errors of the power supplier is not settled on time.

5. By the use of the analog OR gate circuit, the analog AND gate circuit, or the combination of the above circuits, the problem that the motherboard can only receive the PG of one power supplier can be overcome, and various different logic combination of the PG of each power supplier can be achieved to be output as the PG supplied to the motherboard, thereby it is more flexible to determine the condition at which the motherboard can operate normally.

6. The plurality of power suppliers is connected in parallel to further reduce the load of each power supplier. If a part of the power suppliers fail, the remaining power suppliers can still operate normally. In addition, as compared with a single power supplier, the plurality of power suppliers can greatly reduce the cost of the hardware.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power supply device for a personal computer (PC), wherein the PC comprises a motherboard having a first power socket, comprising:
a parallel connection device, comprising:
a first power plug, for connecting to the first power socket;
a second power socket;
a first power line unit, electrically connected between the first power plug and the second power socket;
a third power socket; and
a second power line unit, electrically connected between the first power plug and the third power socket;
a first power supplier, having a second power plug, for connecting to the second power socket to provide power to the motherboard; and
a second power supplier, having a third power plug, for connecting to the third power socket to provide power to the motherboard.

2. The power supply device as claimed in claim 1, wherein the second power line unit comprises:
a delay device, for delaying a control signal of the motherboard.

3. The power supply device as claimed in claim 2, wherein the delay device comprises:
a transistor, having a gate end coupled to the first power plug, a collector coupled to a first voltage, and an emitter coupled to the third power socket;
a resistor, having a first end coupled to the emitter of the transistor; and
a capacitor, having a first end coupled to the second end of the resistor, and a second end coupled to a second voltage.

4. The power supply device as claimed in claim 1, wherein the first and the second power line units respectively comprise:
a diode unit, for preventing counter current.

5. The power supply device as claimed in claim 4, wherein the first and the second power line units respectively further comprise:
a feedback switching switch, coupled between the diode unit and the first power plug, for compensating a voltage drop caused by the diode unit.

6. The power supply device as claimed in claim 4, wherein the first and the second power suppliers respectively comprise:
a feedback switching switch, for compensating the voltage drop caused by the diode unit.

7. The power supply device as claimed in claim 1, further comprising:
a first warning circuit, for monitoring whether the first power supplier operates normally or not; and
a second warning circuit, for monitoring whether the second power supplier operates normally or not.

8. The power supply device as claimed in claim 1, wherein the first and the second power suppliers are ATX, SFX, LFX, or TFX specification.

9. The power supply device as claimed in claim 1, wherein the parallel connection device comprises:
an analog OR gate circuit, having a first input end receiving a first power good (PG) signal of the first power supplier, and a second input end receiving a second PG signal of the second power supplier, and an output end providing a third PG signal to the motherboard.

10. The power supply device as claimed in claim 1, wherein the parallel connection device comprises:
an analog AND gate circuit, having a first input end receiving a first PG signal of the first power supplier, a second input end receiving a second PG signal of the second power supplier, and an output end providing a third PG signal to the motherboard.

11. A parallel connection device of multi power suppliers of a PC, wherein the PC comprises a motherboard, a first power supplier, and a second power supplier, comprising:
a first power plug, for connecting to a first power socket of the motherboard;
a second power socket;
a first power line unit, electrically connected between the first power plug and the second power socket;
a third power socket; and
a second power line unit, electrically connected between the first power plug and the third power socket;
wherein the first power supplier has a second power supplier for connecting to the second power socket to provide power to the motherboard, and the second power supplier has a third power plug for connecting to the third power socket to provide power to the motherboard.

12. The parallel connection device of multi power suppliers of the PC as claimed in claim 11, wherein the second power line unit comprises:
a delay device, for delaying the control signal of the motherboard.

13. The parallel connection device of multi power suppliers of the PC as claimed in claim 12, wherein the delay device comprises:
a transistor, having a gate end coupled to the first power plug, a collector coupled to a first voltage, and an emitter coupled to the third power socket;
a resistor, having a first end coupled to the emitter of the transistor; and
a capacitor, having a first end coupled to the second end of the resistor, and a second end of the capacitor coupled to a second voltage.

14. The parallel connection device of multi power suppliers of the PC as claimed in claim 11, wherein the first and the second power line units respectively comprise:
a diode unit, for preventing counter current.

15. The parallel connection device of multi power suppliers of the PC as claimed in claim 14, wherein the first and the second power line units respectively further comprise:
a feedback switching switch, coupled between the diode unit and the first power plug, for compensating the voltage drop caused by the diode unit.

16. The parallel connection device of multi power suppliers of the PC as claimed in claim 14, wherein the first and the second power suppliers respectively comprise:
a feedback switching switch, for compensating the voltage drop caused by the diode unit.

17. The parallel connection device of multi power suppliers of the PC as claimed in claim 11, wherein the PC further comprises:
a first warning circuit, for monitoring whether the first power supplier operates normally or not; and
a second warning circuit, for monitoring whether the second power supplier operates normally or not.

18. The parallel connection device of multi power suppliers of the PC as claimed in claim 11, wherein the first and the second power suppliers are ATX, SFX, LFX, or TFX specification.

19. The parallel connection device of multi power suppliers of the PC as claimed in claim 11, further comprising:
an analog OR gate circuit, having a first input end receiving a first PG signal of the first power supplier, and a second input end receiving a second PG signal of the second power supplier, and an output end providing a third PG signal to the motherboard.

20. The parallel connection device of multi power suppliers of the PC as claimed in claim 11, further comprising:
an analog AND gate circuit, having a first input end receiving a first PG signal of the first power supplier, a second input end receiving a second PG signal of the second power supplier, and an output end providing a third PG signal to the motherboard.
